(19) United States
(12) Patent Application Publication
(10) Pub. No.: US 2007/0068842 A1
(43) Pub. Date: Mar. 29, 2007

(54) Cover film for blister packs

(75) Inventor: Erwin Pasbrig, Singen (DE)

Correspondence Address: FISHER, CHRISTEN & SABOL, 1725 K STREET, N.W., SUITE 1108, WASHINGTON, DC, 20006, US

(73) Assignee: ALCAN TECHNOLOGY & MANAGEMENT LTD., NEUHAUSEN AM RHIENFALL (CH)

(21) Appl. No.: 10/553,123

(22) PCT Filed: Apr. 5, 2004
(86) PCT No.: PCT/EP04/03583

§ 371 Date: Oct. 14, 2005

(30) Foreign Application Priority Data
Apr. 16, 2003 (EP) 03405269.6

(51) Int. Cl. B65D 83/04

(52) U.S. Cl. 206/532; 428/549

(57) ABSTRACT

A covering foil for thermoformed and cold-formed blisters for the child-proof and elderly friendly packaging of medicaments and of medical products. The covering foil includes a 5 to 30 μm thick aluminum foil, which is uncoated on a first side, or is painted with a protective paint with an application weight ranging from 0.1 to 10 g/m² or is laminated with paper having a mass per unit area ranging from 17 to 60 g/m² or is laminated with a 5 to 15 μm thick polyester film. On the second side, which is provided for sealing against a blister bottom part, the aluminum foil is laminated with a non-monoaxially or non-biaxially drawn plastic film based on polyvinylchloride (PVC) having a film thickness ranging from 10 to 40 μm or polyvinylidene chloride (PVDC) also having a film thickness ranging from 10 to 40 μm or polypropylene (PP) having a film thickness ranging from 6 to 35 μm or polyester having a film thickness ranging from 5 to 15 μm or polychlorotrifluoroethylene (PCTFE) having a film thickness ranging from 8 to 76 μm or cyclo-oletin copolymers (COC) having a thickness ranging form 10 to 40 μm. It is possible to push through the aluminum/plastic laminate, however, the plastic film makes it difficult for children to bite through.

The invention concerns a cover film for blister packs with thermoformed or cold-formed blister base parts for child-safe and senior-friendly packing of pharmaceutical products.

To fulfil the requirements of blister packs for child safety and ease of use by the elderly, cover films are used in the form of press-through, peel and peel-press films in combination with corresponding base films and blister designs. Because of different legislative regulations, the blister packs released in one country are not automatically also licensed for use in another country.

In the USA, all blister packs with a new product that must be child-safe and senior-friendly must be tested in a practical test. A decisive criterion here is that the children of test age are asked to take the blister pack in their mouths and bite on it. For this reason, in the USA laminated materials with the layer sequence paper/PET/aluminium/hot seal layer are used as cover films. As it is scarcely possible now to bite through this cover film, also the product in the blister cannot be removed from the packing by pressing out. The cover film is therefore designed either as a peel or as a peel-press film, or the blister pack can be torn open by way of opening aids from the base part. Due to the bite-proof design of the cover film, these blister packs necessarily have cross perforations and concealed opening aids. This leads to a substantial enlargement of the blisters in comparison with a press-through packaging with a conventional press-through film. The increase in blister dimensions of at least 3 mm in width and at least 12 mm in length leads to a lower yield by area and hence a reduction in the number of blisters per moulding cycle in production of the blister packs.

In contrast to the USA, in Europe there are no uniform regulations on child-safe and senior-friendly blister packs. The following combinations of cover films and base parts have been tested and published in Germany:

| Cover film | Base material |
|---|---|
| 50 g/m² paper/9 μm Al film/7 g/m² HSL | PVC, ACLAR ® |
| (hot seal lacquer) | (PCTFE) |
| Purelay lid (PE), 70-100 μm | PP |
| (cross perforation) | |
| 23 μm PET film/peel adhesive/20 μm Al film/ | PP, Formpack ® PP |
| 5.5 g/m² HSL | (Al/PP) |
| 40 g/m² paper/7 μm Al film/3.5 g/m² HSL | PP |
| Lacquer/30 μm Al film, hard, embossed/9 g/m² | PVC |
| HSL | |
| 50 g/m² paper/9 μm Al film/7 g/m² HSL | PVC |
| 35 g/m² paper/9 μm Al film/7 g/m² HSL | PVC |
| Lacquer/25 μm Al film/9 g/m² HSL | PVC |
| (cross perforation) | |

The press-through properties are tested mechanically. Here, a semi-circular die is pressed at a defined speed onto the inside of the film which is clamped in a holder. The force necessary to press through is given in Newtons.

The following forms of cover film used in many European countries have press-through forces between 38 and 56 N (standard deviation approx. 8):

| | Press through force |
|---|---|
| Cover film | (N) |
| 50 g/m² paper/9 μm Al film/7 g/m² HSL | 48 |
| 40 g/m² paper/7 μm Al film/3.5 g/m² HSL | 41 |
| Protective lacquer/30 μm Al film, hard, | 56 |
| embossed/9 g/m² HSL | |
| 35 g/m² paper/9 μm Al film/7 g/m² HSL | 38 |
| Protective lacquer/25 μm Al film/9 g/m² | 38 |
| HSL (cross perforation) | |

In contrast to the test regulations applicable to the USA, packaging in Europe need only be tested once in the above method and is then generally licensed as child-safe for all products. As part of new draft legislation however, efforts are being made to include in European tests the bite test, compulsory in the USA, as a decisive criterion for the licensing of child-safe packing. For pharmaceutical companies, this would mean that new primary packing means must be used. This is associated with highly cost-intensive stability tests, the packing machines must be converted and productivity in blister production falls.

The invention is based on the object of creating a cover film which is suitable for sealing to all common base materials, which allows a child-safe and senior-friendly opening of blister packs including tropical blisters by press through, and which can be used on existing packing machines without conversion.

The object is achieved by the invention with a 5 to 30 μm thick aluminium film which on a first side
is uncoated, or
is coated with a protective lacquer with a coating weight of 0.1 to 10 g/m², or
is laminated with paper with a substance weight of 17 to 60 g/m², or
is laminated with a 5 to 15 μm thick polyester film
   and on the second side which is intended for sealing to a blister base part, is laminated with a non-oriented or a monoaxially or biaxially oriented plastic film on the basis of
polyvinyl chloride (PVC) with a film thickness of 10 to 40 μm, or
polyvinylidene chloride (PVDC) with a film thickness of 10 to 40 μm, or
polypropylene (PP) with a film thickness of 6 to 35 μm, or
polyester with a film thickness of 5 to 15 μm, or
polychlorotrifluoroethylene (PCTFE) with a film thickness of 8 to 76 μm, or
cyclo-olefin copolymers (COC) with a thickness of 10 to 40 μm.

The material of the plastic film which is intended for sealing to the blister base part is selected according to the material of the side of the blister base part intended for sealing. Thus, compatibility is ensured between the chemical structure of the side of the cover film according to the invention which comes into contact with the product, and the chemical structure of the side of a base film previously used and licensed which comes into contact with the product, so that the performance of new stability tests is not absolutely necessary.

The desired blister packs with the cover film according to the invention can be produced on existing machines.

The aluminium film preferably has a thickness of 7 to 30 μm.

Preferably, the protective lacquer layer on the first side of the aluminium film comprises a lacquer based on watery or organic solvents on the basis of nitrocellulose, epoxy resin, urea resin, melamine resin, polyester, polyurethane or mixtures of the said lacquer raw materials, where the preferred coating weight of the protective lacquer layer is 0.5 to 5 g/m².

The paper on the first side of the aluminium film can be glassine paper, glassine-substitute paper, coated or satinised paper with a preferred substance weight of 19 to 50 g/m².

Preferably, the paper or polyester film on the first side of the aluminium film is pasted to the aluminium film with a watery, a solvent-based or a solvent-free adhesive.

The plastic film on the second side of the aluminium film can be pasted to the aluminium film with a watery, a solvent-based or a solvent-free adhesive or by extrusion laminating.

In a blister pack with a blister base part and a cover film according to the invention sealed to the blister base part, the blister base part comprises, at least on the side which is sealed to the cover film, a material whose chemical structure is compatible with that of the plastic film which is sealed to the blister base part. Preferably, the blister base part, at least on the side sealed to the cover film, comprises the same material as the plastic film which is sealed to the blister base part.

Examples of materials used for the production of blister base parts are films of PVC, PVDC, PP, PET, PE and laminated films such as PVC/ACLAR® (PCTFE), PVC/PVDC and COC or FORMPACK® (Al-Al blister).

It should be stated here that both the cover film and the base film can be printed.

The table below gives examples of cover films according to the invention with associated press-through force. The term “outer coating” indicates the coating of the aluminium film which is directed towards the outside, and the term “inner coating” indicates that intended for sealing to the blister base part, in each case stating the substance weight for lacquer and for paper coating or the film thickness for film coating, and the type of connection between the coating and the aluminium film.

| | Outer | Aluminium | Inner | Press through |
|---|---|---|---|---|
| Example | coating | film | coating | force (N) |
| 1 | Protective lacquer | 20 μm, hard | PVC film, 15 μm, | 44 |
| | 1.0 g/m², lacquered | | lacquer-laminated | |
| 2 | Protective lacquer | 25 μm, soft | PVC film, 25 μm, | 54 |
| | 1.0 g/m², lacquered | | lacquer-laminated | |
| 3 | Paper 21 g/m², | 20 μm, hard | PVC film, 15 μm, | 59 |
| | laminated | | lacquer-laminated | |
| 4 | Protective lacquer | 20 μm, hard | PVC film, 25 μm, | 61 |
| | 1.0 g/m², lacquered | | lacquer-laminated | |
| 5 | Protective lacquer | 20 μm, hard | PVDC film, 25 μm, | 77 |
| | 1.0 g/m², lacquered | | lacquer-laminated | |
| 6 | Protective lacquer | 20 μm, hard | PVC film, 30 μm, | 105 |
| | 1.0 g/m², lacquered | | lacquer-laminated | |
| 7 | Protective lacquer | 20 μm, hard | PVC film, 40 μm, | 48 |
| | 1.0 g/m², lacquered | | lacquer-laminated | |
| 8 | Protective lacquer | 20 μm, hard | ACLAR ® film, 15 μm, | 76 |
| | 1.0 g/m², lacquered | | lacquer-laminated | |
| 9 | PET film 7 μm, | 9 μm, soft | PET film, 7 μm, | 94 |
| | laminated | | laminated | |
| 10 | Protective lacquer | 20 μm, hard | Monoax. PP film, 30 μm, | 89 |
| | 1.0 g/m², lacquered | | lacquer-laminated | |
| 11 | Protective lacquer | 20 μm, hard | Monoax. PP film, 20 μm, | 90 |
| | 1.0 g/m², lacquered | | extrusion-laminated (7 g/m²) | |
| 12 | Protective lacquer | 25 μm, hard | Monoax. PVC film, 35 μm, | 48 |
| | 1.0 g/m², lacquered | | extrusion-laminated (7 g/m²) | |
| 13 | Glassine paper | 9 μm, soft | PVC film, 15 μm, | 20 |
| | 35 g/m², laminated | | lacquer-laminated | |
| 14 | Protective lacquer | 20 μm, hard | COC film, 20 μm, | |
| | 1.0 g/m², lacquered | | lacquer-laminated | |

1. A cover film for thermoformed or cold-formed blisters for child-safe and senior-friendly packing of medicines and medicinal products, characterized by a 5 to 30 μm thick aluminum film which on a first side
is uncoated, or
is coated with a protective lacquer with a coating weight of 0.1 to 10 g/m², or
is laminated with paper with a substance weight of 17 to 60 g/m², or
is laminated with a 5 to 15 μm thick polyester film
and on the second side which is intended for sealing to a blister base part, is laminated with a non-oriented or a monoaxially or biaxially oriented plastic film on the basis of
polyvinyl chloride (PVC) with a film thickness of 10 to 40 μm, or
polyvinylidene chloride (PVDC) with a film thickness of 10 to 40 μm, or
polypropylene (PP) with a film thickness of 6 to 35 μm, or
polyester with a film thickness of 5 to 15 μm, or
polychlorotrifluoroethylene (PCTFE) with a film thickness of 8 to 76 μm, or
cyclo-olefin copolymers (COC) with a thickness of 10 to 40 μm.

2. The cover film according to claim 1, wherein the aluminum film is in the soft or hard state or has a defined hardness.

3. The cover film according to claim 1 or, wherein the aluminum film is 7 to 30 μm thick.

4. The cover film according to claim 1, wherein the protective lacquer layer on the first side of the aluminum film comprises a lacquer based on watery or organic solvents on the basis of nitrocellulose, epoxy resin, urea resin, melamine resin, polyester, polyurethane or mixtures of the said lacquer raw materials.

5. The cover film according to claim 21, wherein the coating weight of the protective lacquer layer is 0.5 to 5 g/m².

6. The cover film according to claim 1, wherein the paper on the first side of the aluminum film is glassine paper, glassine-substitute paper, coated or satinized paper.

7. The cover film according to claim 6, wherein the paper has a substance weight of 19 to 50 g/m².

8. The cover film according to claim 1, wherein the paper or the polyester film on the first side of the aluminum film is pasted to the aluminum film with a watery, a solvent-based or a solvent-free adhesive.

9. The cover film according to claim 1, wherein the plastic film on the second side of the aluminum film is pasted to the aluminum film with a watery, a solvent-based or a solvent-free adhesive or by extrusion laminating.

10. A blister pack with a blister base part and a cover film sealed to the blister base part, wherein the cover film is a 5 to 30 μm thick aluminum film which on a first side
is uncoated, or
is coated with a protective lacquer with a coating weight of 0.1 to 10 g/m², or
is laminated with paper with a substance weight of 17 to 60 g/m², or
is laminated with a 5 to 15 μm thick polyester film
and on the second side which is intended for sealing to a blister base part, is laminated with a non-oriented or a monoaxially or biaxially oriented plastic film on the basis of
polyvinyl chloride (PVC) with a film thickness of 10 to 40 μm, or
polyvinylidene chloride (PVDC) with a film thickness of 10 to 40 μm, or
polypropylene (PP) with a film thickness of 6 to 35 μm, or
polyester with a film thickness of 5 to 15 μm, or
polychlorotrifluoroethylene (PCTFE) with a film thickness of 8 to 76 μm, or
cyclo-olefin copolymers (COC) with a thickness of 10 to 40 μm,
and in that the blister base part at least on the side which is sealed to the cover film comprises a material whose chemical structure is compatible with that of the plastic film which is sealed to the blister base part.

11. A blister pack according to claim 10, wherein the blister base part on at least the side which is sealed to the cover film comprises the same material as the plastic film which is sealed to the blister base part.

12. A blister pack according to claim 10 wherein the aluminum film is in the soft or hard state or has a defined hardness.

13. A blister pack according to claim 10, wherein the aluminum film is 7 to 30 μm thick.

14. A blister pack according to claim 10, wherein the protective lacquer layer on the first side of the aluminum film comprises a lacquer based on watery or organic solvents on the basis of nitrocellulose, epoxy resin, urea resin, melamine resin, polyester, polyurethane or mixtures of the said lacquer raw materials.

15. A blister pack according to claim 14, wherein the coating weight of the protective lacquer layer is 0.5 to 5 g/m².

16. A blister pack according to claim 10, wherein the paper on the first side of the aluminum film is glassine paper, glassine-substitute paper, coated or satinized paper.

17. The blister pack according to claim 16, wherein the paper has a substance weight of 19 to 50 g/m².

18. The blister pack according to claim 10, wherein the paper or the polyester film on the first side of the aluminum film is pasted to the aluminum film with a watery, a solvent-based or a solvent-free adhesive.

19. The blister pack according to claim 10, wherein the plastic film on the second side of the aluminum film is pasted to the aluminum film with a watery, a solvent-based or a solvent-free adhesive or by extrusion laminating.

20. The cover film according to claim 2, wherein the aluminum film is 7 to 30 μm thick.

21. The cover film according to claim 20, wherein the protective lacquer layer on the first side of the aluminum film comprises a lacquer based on watery or organic solvents on the basis of nitrocellulose.

22. The cover film according to claim 20, wherein the paper on the first side of the aluminum film is glassine paper, glassine-substitute paper, coated or satinized paper.

23. The cover film according to claim 20, wherein the paper or the polyester film on the first side of the aluminum film is pasted to the aluminum film with a watery, a solvent-based or a solvent-free adhesive.

24. The cover film according to claim 23, wherein the plastic film on the second side of the aluminum film is pasted to the aluminum film with a watery, a solvent-based or a solvent-free adhesive or by extrusion laminating.

25. The blister pack according to claim 11, wherein the aluminum film is in the soft or hard state or has a defined hardness.

26. The blister pack according to claim 25, wherein the aluminum film is 7 to 30 μm thick.

27. The blister pack according to claim 26, wherein the protective lacquer layer on the first side of the aluminum film comprises a lacquer based on watery or organic solvents on the basis of nitrocellulose, epoxy resin, urea resin, melamine resin, polyester, polyurethane or mixtures of the said lacquer raw materials.

28. The blister pack according to claim 26, wherein the paper on the first side of the aluminum film is glassine paper, glassine-substitute paper, coated or satinized paper.

29. The blister pack according to claim 26, wherein the paper or the polyester film on the first side of the aluminum film is pasted to the aluminum film with a watery, a solvent-based or a solvent-free adhesive.

30. The blister pack according to claim 29, wherein the plastic film on the second side of the aluminum film is pasted to the aluminum film with a watery, a solvent-based or a solvent-free adhesive or by extrusion laminating.
